(19) United States
(12) Patent Application Publication
(10) Pub. No.: US 2024/0119110 A1
(43) Pub. Date: Apr. 11, 2024

(54) METHOD, APPARATUS, ELECTRONIC DEVICE AND COMPUTER-READABLESTORAGE MEDIUM FOR COMPUTATIONAL FLOW GRAPH SCHEDULINGSCHEME GENERATION

(71) Applicant: Beijing Stream Computing Inc., Beijing (CN)

(72) Inventors: Rui Cao, Beijing (CN); Wenyuan Lv, Beijing (CN); Xiaoqiang Dan, Beijing (CN); Lei Liu, Beijing (CN)

(73) Assignee: Beijing Stream Computing Inc., Beijing (CN)

(21) Appl. No.: 18/525,488

(22) Filed: Nov. 30, 2023

Related U.S. Application Data
(63) Continuation of application No. PCT/CN2022/086761, filed on Apr. 14, 2022.

(30) Foreign Application Priority Data
Jun. 3, 2021 (CN) 202110620358.4

(51) Int. Cl. G06F 17/11

(52) U.S. Cl. CPC G06F 17/11

(57) ABSTRACT

A method for generating a computation flow graph scheduling scheme includes grouping original vertexes in an original computation flow graph, so as to obtain first computation flow graphs; determining the number N of computing units required to process a single batch of computation data in parallel; copying N first computation flow graphs, so as to obtain second computation flow graphs; adding auxiliary vertexes to the second computation flow graphs, so as to obtain third computation flow graphs; constructing integer linear programming according to the third computation flow graphs; and solving the integer linear programming, so as to obtain a scheduling scheme for the third computation flow graphs. The method converts an original computation flow graph into third computation flow graphs and integer linear programming is constructed to obtain a scheduling scheme.

### CROSS-REFERENCE TO RELATED APPLICATIONS

This application is a continuation application of International Patent Application No. PCT/CN2022/086761 filed on Apr. 14, 2022, which in turn claims priority to Chinese Patent Application No. 202110620358.4, entitled “Method, Apparatus, Electronic Device and Computer-readable Storage Medium for Computational Flow Graph Scheduling Scheme Generation,” filed on 3 Jun. 2021, the entirety of which is incorporated by reference for all purposes.

### TECHNICAL FIELD

The present disclosure relates to the field of computational flow graph scheduling, and more particularly, to a method, an apparatus, an electronic device and a computer-readable storage medium for computational flow graph scheduling scheme generation.

### BACKGROUND OF THE INVENTION

A deep learning (DL) model may be represented as a directed acyclic graph (DAG) where vertices in the graph represent computational operations in the model, and directed edges represent data flows between different computational operations.

DL models deployed on hardware may generally be divided into two scenarios training models and inference models. In both scenarios, it is necessary to decide on a scheduling scheme for execution of the DL model. The scheduling scheme includes: an execution sequence of vertices in DAG, computing devices and resources used upon each vertex being executed, and storage devices and resources used for data generated after each vertex is executed, etc.

In the scenario where the model is trained, storage media with high bandwidth, such as a high bandwidth memory (HBM), are generally used, and data transmission speed generally does not constitute a performance bottleneck. However, in the scenario of the inference model, the data transmission speed becomes an important factor affecting the inference performance because inference chips generally use storage media with relatively limited bandwidth, such as DDR SDRAM (double data rate synchronous dynamic random access memory).

Currently, main directions of computational scheduling algorithms for DL models are:

Vertex fusion: Fuse the vertices with data dependencies in the computational graph into one vertex, that is, the output data of the upstream vertex will be directly given to the downstream vertex for consumption, without caching operations on storage resources. This can reduce the time consumed originally for data transfer between the two vertices. However, this solution generally uses expert experience to fuse the specified types of computation vertices in the DAG, rewrites the DAG based on the fusion results, and arranges the vertex computation order based on the topological ordering of the rewritten DAG. This relies heavily on expert experience, and it is not applicable to all model structures.

Multi-device allocation: According to the computing and storage characteristics of the vertices, assign them to different computing devices and storage devices for execution to improve the computing utilization of each device and reduce consumption due to data transfer. However, this solution does not change the computation order of the original vertices in the DAG, and cannot improve the computational parallelism during model execution.

Vertex copy: Re-compute the results for vertices with low computing requirements but large storage requirements to reserve more cache space for output data of other more frequently reused vertices, thereby reducing the total time spent on data transfer between low-speed cache and high-speed cache throughout the execution of the DAG. This method is equivalent to copying a vertex in the DAG and inserting it into another location. However, this solution cannot improve the computational parallelism during model execution. On the contrary, due to the addition of new vertices to the original DAG, the computational consumption of the entire model is increased.

### SUMMARY

This Summary is provided to introduce in a simplified form of concepts that are further described in the Detailed Description. This Summary is not intended to identify key features or essential features of the claimed technical solution, nor is it intended to be used to limit the scope of the claimed technical solution.

In order to solve the above technical problems in the prior art, embodiments of the present disclosure provide the following technical solutions:

In a first aspect, the embodiments of the present disclosure provide a method for computational flow graph scheduling scheme generation, comprising:

A method for computational flow graph scheduling scheme generation, comprising:
grouping original vertexes in an original computational flow graph to obtain a first computational flow graph, each group being a vertex in the first computational flow graph, the vertex being a set formed by at least one original vertex in the original computational flow graph;
determining a number N of computing units required for parallel processing of a single batch of computational data according to storage resource requirements of the vertices in the first computational flow graph and storage resources of the computing units, N being an integer greater than or equal to 1;
making N copies of the first computational flow graphs to obtain a second computational flow graph;
adding auxiliary vertices into the second computational flow graph to obtain a third computational flow graph;
constructing an integer linear programming problem corresponding to the third computational flow graph according to the third computational flow graph;
solving the integer linear programming problem to obtain a scheduling scheme of the third computational flow graph; and
simplifying the scheduling scheme of the third computational flow graph to form a scheduling scheme of the second computational flow graph.

Optionally, grouping the original vertexes in the original computational flow graph to obtain the first computational flow graph comprises:
grouping the original vertices in the original computational flow graph according to input data and output data of the original vertices in the original computational flow graph to obtain the first computational flow graph

Optionally, determining the number N of computing units required for parallel processing of the single batch of computational data according to the storage resource requirements of the vertices in the first computational flow graph and the storage resources of the computing units comprises:
acquiring a maximum storage requirement of the vertices in the first computational flow graph; and
calculating the number N of computing units required for parallel processing of the single batch of computational data according to the maximum storage requirement and the storage resources of the computing units.

Optionally, determining the number N of computing units required for parallel processing of the single batch of computational data according to the maximum storage requirement and the storage resources of the computing units comprises:
calculating the number N of the computing units according to the following formula: 2^{[log}^{₂}^{[M/m]]},
where M represents the maximum storage requirement, and m represents a size of a storage space of a single computing unit.

Optionally, making N copies of the first computational flow graphs to obtain the second computational flow graph comprises:
replicating the first computational flow graph by the number N; and
combining the number N of the first computational flow graphs to generate the second computational flow graph, wherein the second computational flow graph is used for parallel processing of a plurality of batches of data.

Optionally, the auxiliary vertices comprise: a first auxiliary vertex representing an input data reading operation in the original computational flow graph, a second auxiliary vertex representing an intermediate result computational operation for the vertexes in the original computational flow graph, and a third auxiliary vertex representing a computation terminating operation in the second computational flow graph.

Optionally, constructing the integer linear programming problem corresponding to the third computational flow graph according to the third computational flow graph comprises:
obtaining values of R_{t,i}, S_{t,i}, L_{t,i} and F_{t,i}, such that a value of the following polynomial is minimum:

$${\sum }_{t = 1}^{T} {\sum }_{i = 1}^{N} ( {L}_{t , i} + {S}_{t , i} ) {C}_{i}$$

where i indicates a serial number of the vertex in the third computational flow graph; t indicates a time step; R_{t,i} indicates whether the result of the i^{th} vertex is calculated at a t^{th} time step; S_{t,i} indicates whether the computational result of the i^{th} vertex is stored in a low-speed cache at the t^{th} time step; L_{t,i} indicates whether the computational result of the i^{th} vertex is read from the low-speed cache to a cache of a computing unit at the t^{th} time step; F_{t,i} indicates whether a space occupied by the computational result of the i^{th} vertex in the cache of the computing unit is released at the t^{th} time step; Cᵢ indicates a consumption required to transmit the computational result of the i^{th} vertex between the low-speed cache and the cache of the computing unit; R_{t,i} is equal to 0 or 1, S_{t,i} is equal to 0 or 1, L_{t,i} is equal to 0 or 1, and F_{t,i} is equal to 0 or 1; 0 means not performing a corresponding operation, and 1 means performing the corresponding operation; T and N are integers greater than 1; wherein the integer linear programming problem further comprises constraints of the R_{t,i}, S_{t,i}, L_{t,i} and F_{t,i}; and the constraints are determined by hardware performances of the computing unit.

Optionally, solving the integer linear programming problem to obtain the scheduling scheme of the third computational flow graph comprises:
encoding the integer linear programming problem; and
solving the encoding to obtain an execution sequence of the vertices in the third computational flow graph.

Optionally, simplifying the scheduling scheme of the third computational flow graph to form the scheduling scheme of the second computational flow graph comprises:
deleting the auxiliary vertices in the scheduling scheme of the third computational flow graph to obtain the scheduling scheme of the second computational flow graph.

Further, the method may also include:
determining an amount of data processed by each vertex in the scheduling scheme according to the number of computing units and the number N.

In a second aspect, the embodiments of the present disclosure provide an apparatus for computational flow graph scheduling scheme generation, comprising:
a first computational flow graph generating module, configured to group original vertexes in an original computational flow graph to obtain a first computational flow graph, each group being a vertex in a first computational flow graph, the vertex being a set formed by at least one original vertex in the original computational flow graph;
a computing unit number determining module, configured to determine a number N of computing units required for parallel processing of a single batch of computational data according to storage resource requirements of the vertices in the first computational flow graph and storage resources of the computing units, N being an integer greater than or equal to 1;
a second computational flow graph generating module, configured to make N copies of the first computational flow graphs to obtain a second computational flow graph;
a third computational flow graph generating module, configured to add auxiliary vertices into the second computational flow graph to obtain a third computational flow graph;
an integer linear programming problem constructing module, configured to construct an integer linear programming problem corresponding to the third computational flow graph according to the third computational flow graph;
an integer linear programming problem solving module, configured to solve the integer linear programming problem to obtain a scheduling scheme of the third computational flow graph; and
a simplifying module, configured to simplify the scheduling scheme of the third computational flow graph to form a scheduling scheme of the second computational flow graph.

Optionally, the first computational flow graph generating module is further configured to: group the original vertices in the original computational flow graph according to input data and output data of the original vertices in the original computational flow graph to obtain the first computational flow graph.

Optionally, the computing unit number determining module is further configured to: acquire a maximum storage requirement of the vertices in the first computational flow graph; and calculate the number N of computing units required for parallel processing of the single batch of computational data according to the maximum storage requirement and the storage resources of the computing units.

Optionally, the computing unit number determining module is further configured to: calculate the number N of the computing units according to the following formula: 2^{[log}^{₂}^{[M/m]]}, where M represents the maximum storage requirement, and m represents a size of a storage space of a single computing unit.

Optionally, the second computational flow graph generating module is further configured to: replicate the first computational flow graph by the number N; and combine the number N of the first computational flow graphs to generate the second computational flow graph, wherein the second computational flow graph is used for parallel processing of a plurality of batches of data.

Optionally, the auxiliary vertices comprise: a first auxiliary vertex representing an input data reading operation in the original computational flow graph, a second auxiliary vertex representing an intermediate result computational operation for the vertexes in the original computational flow graph, and a third auxiliary vertex representing a computation terminating operation in the second computational flow graph.

Optionally, the integer linear programming problem constructing module is further configured to: obtain values of R_{t,i}, S_{t,i}, L_{t,i} and F_{t,i}, such that a value of the following polynomial is minimum:

$${\sum }_{t = 1}^{T} {\sum }_{i = 1}^{N} ( {L}_{t , i} + {S}_{t , i} ) {C}_{i}$$

where i indicates a serial number of the vertex in the third computational flow graph; t indicates a time step; R_{t,i} indicates whether the result of the i^{th} vertex is calculated at a t^{th} time step; S_{t,i} indicates whether the computational result of the i^{th} vertex is stored in a low-speed cache at the t^{th} time step; L_{t,i} indicates whether the computational result of the i^{th} vertex is read from the low-speed cache to a cache of a computing unit at the t^{th} time step; F_{t,i} indicates whether a space occupied by the computational result of the i^{th} vertex in the cache of the computing unit is released at the t^{th} time step; Cᵢ indicates a consumption required to transmit the computational result of the i^{th} vertex between the low-speed cache and the cache of the computing unit; R_{t,i} is equal to 0 or 1, S_{t,i} is equal to 0 or 1, L_{t,i} is equal to 0 or 1, and F_{t,i} is equal to 0 or 1; 0 means not performing a corresponding operation, and 1 means performing the corresponding operation; T and N are integers greater than 1; wherein the integer linear programming problem further comprises constraints of the R_{t,i}, S_{t,i}, L_{t,i} and F_{t,i}; and the constraints are determined by hardware performances of the computing unit.

Optionally, the integer linear programming problem solving module is further configured to: encode the integer linear programming problem; and solve the encoding to obtain an execution sequence of the vertices in the third computational flow graph.

Optionally, the simplifying module is further configured to: delete the auxiliary vertices in the scheduling scheme of the third computational flow graph to obtain the scheduling scheme of the second computational flow graph.

Optionally, the apparatus for computational flow graph scheduling scheme generation is further configured to: determine an amount of data processed by each vertex in the scheduling scheme according to the number of computing units and the number N.

In a third aspect, the embodiments of the present disclosure provide an electronic device, including: a memory for storing computer-readable instructions; and one or more processors for executing the computer-readable instructions, which, upon execution, cause the processors to implement any one of the methods in the first aspect.

In a fourth aspect, the embodiments of the present disclosure provide a non-transitory computer-readable storage medium, the non-transitory computer-readable storage medium storing computer-readable instructions for causing a computer to perform any one of the methods in the first aspect.

In a fifth aspect, the embodiments of the present disclosure provide a computer program product, including computer instructions, wherein, when the computer instructions are executed by a computing device, the computing device performs any one of the methods of the first aspect.

The embodiments of the present disclosure provide a method, apparatus, electronic device and computer-readable storage medium for computational flow graph scheduling scheme generation. The method for computational flow graph scheduling scheme generation comprises: grouping original vertexes in an original computational flow graph to obtain a first computational flow graph, each group being a vertex in the first computational flow graph, the vertex being a set formed by at least one original vertex in the original computational flow graph; determining a number N of computing units required for parallel processing of a single batch of computational data according to storage resource requirements of the vertices in the first computational flow graph and storage resources of the computing units, N being an integer greater than or equal to 1; making N copies of the first computational flow graphs to obtain a second computational flow graph; adding auxiliary vertices into the second computational flow graph to obtain a third computational flow graph; constructing an integer linear programming problem corresponding to the third computational flow graph according to the third computational flow graph; solving the integer linear programming problem to obtain a scheduling scheme of the third computational flow graph; and simplifying the scheduling scheme of the third computational flow graph to form a scheduling scheme of the second computational flow graph. The above method for computational flow graph scheduling scheme generation solves the technical problems of low data reuse rate or low parallelism in the existing technology by converting the original computational flow graph into a third computational flow graph and constructing an integer linear programming problem to obtain a scheduling scheme.

The above description is only an overview of the technical solutions of the present disclosure. For a clearer understanding of the technical means of the present disclosure for implementation according to the content of the specification, and to make the above and other objectives, features, and advantages of the present disclosure clearer and more comprehensible, detailed description is provided as follows with reference to preferred embodiments and the accompanying drawings.

### BRIEF DESCRIPTION OF DRAWINGS

The above and other features, advantages and aspects of various embodiments of the present disclosure will become more apparent in conjunction with the accompanying drawings and with reference to the following specific embodiments. In the accompanying drawings, the same or similar reference numerals represent the same or similar elements. It should be understood that the accompanying drawings are schematic, and components and elements are not necessarily drawn to scale.

FIG. 1 is a schematic flowchart of a method for computational flow graph scheduling scheme generation in an embodiment of the present disclosure;

FIG. 2 is an exemplary schematic diagram of an original computational flow graph in an embodiment of the present disclosure;

FIG. 3 is a schematic diagram of a first computational flow graph in an embodiment of the present disclosure;

FIG. 4 is a further schematic flowchart of a method for computational flow graph scheduling scheme generation in an embodiment of the present disclosure;

FIG. 5 is an exemplary schematic diagram of a second computational flow graph in an embodiment of the present disclosure;

FIG. 6 is an exemplary schematic diagram of a third computational flow graph in an embodiment of the present disclosure;

FIG. 7 is a schematic diagram of an execution sequence of vertices in the third computational flow graph in an embodiment of the present disclosure; and

FIG. 8 is a schematic diagram of a scheduling scheme of a second computational flow graph in an embodiment of the present disclosure.

### DETAILED DESCRIPTION

Embodiments of the present disclosure will be described in greater detail below with reference to the accompanying drawings. While some embodiments of the present disclosure are shown in the accompanying drawings, it should be understood that the present disclosure may be implemented in various forms and should not be construed as being limited to the embodiments set forth herein, instead these embodiments are provided for a more thorough and complete understanding of the present disclosure. It should be understood that the accompanying drawings and embodiments of the present disclosure are for exemplary purposes only and are not intended to limit the scope of protection of the present disclosure.

It should be understood that the individual steps documented in the method embodiments of the present disclosure may be performed in a different order, and/or in parallel. In addition, the method embodiments may include additional steps and/or omit the steps illustrated. The scope of the present disclosure is not limited in this regard.

The term “include” or “comprise” and its variations are used herein as an open inclusion, that is, “including, but not limited to”. The term “based on” means “based, at least in part, on”. The term “an embodiment” means “at least one embodiment”. The term “another embodiment” means “at least one additional embodiment”. The term “some embodiments” means “at least some embodiments”. Relevant definitions of other terms will be given in the description below.

It should be noted that the concepts such as “first” and “second” mentioned in the present disclosure are used only to distinguish between different apparatuses, modules or units, and are not intended to define the order or mutual interdependence of the functions performed by these apparatuses, modules or units.

It should be noted that the modifications of “one”, “a” and “plurality of” referred to in the present disclosure are illustrative rather than limiting, and it should be understood by those skilled in the art to mean “one or more” unless the context clearly indicates otherwise.

The names of messages or information exchanged between the plurality of apparatuses in the embodiments of the present disclosure are used for illustrative purposes only and are not intended to limit the scope of the messages or information.

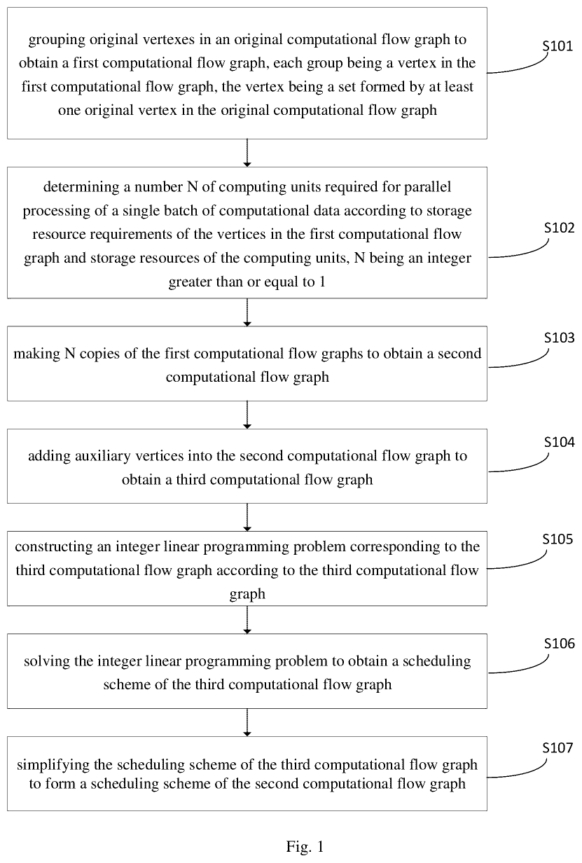

FIG. 1 is a schematic flowchart of a method for computational flow graph scheduling scheme generation as provided by an embodiment of the present disclosure.

The method for computational flow graph scheduling scheme generation is used for generating an execution sequence of vertices in a computational flow graph of a DL model, computing devices and resources used upon each vertex being executed, storage devices and resources used for data generated after each vertex is executed, etc.

As shown in FIG. 1, the method includes the following steps.

In step S101, original vertexes in an original computational flow graph are grouped to obtain a first computational flow graph, each group being a vertex in a first computational flow graph, the vertex being a set formed by at least one original vertex in the original computational flow graph.

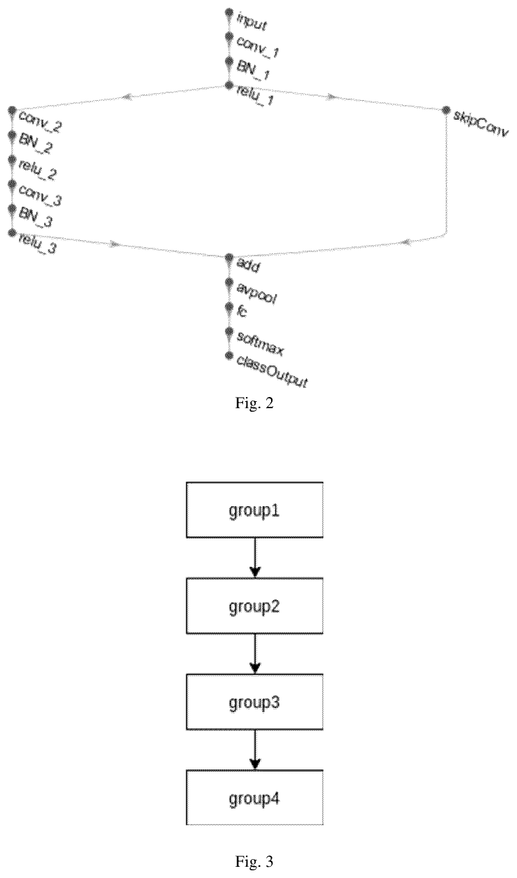

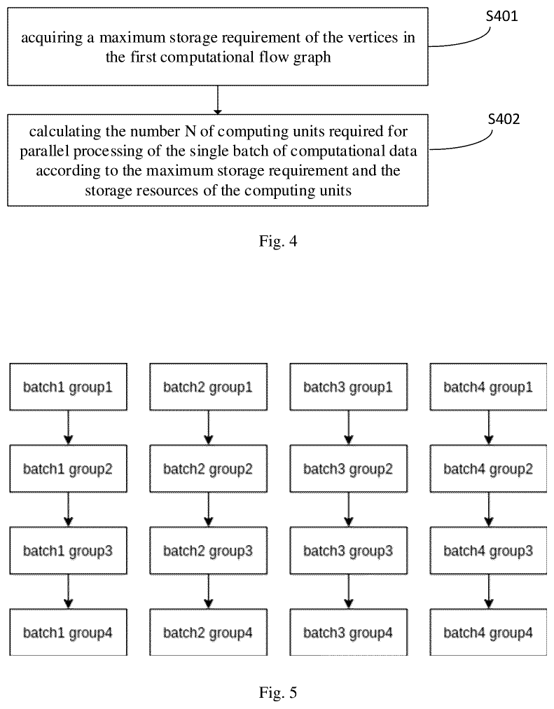

An example of the original computational flow graph is shown in FIG. 2. In this example, the original computational flow graph includes a plurality of original vertexes, each of which represents a computation or operation, such as a convolution operation, an activation operation, an addition operation, a pooling operation, and the like. A directed edge between vertices represents a direction of data flow between the vertices.

In this step, the original vertexes in the original computational flow graph are grouped according to certain rules or according to a preset algorithm. The original vertices assigned in the same group are fused into one fused vertex, and the fused vertex is used as a vertex in the first computational flow graph. The fused vertex is a set formed by at least one original vertex in the original computational flow graph. That is, the computations/operations represented by the original vertices in this set and the directed edges between the original vertices are all taken as the computations/operations and directions of data flow in the vertex in the first computational flow graph.

Grouping the original vertices in the original computational flow graph to obtain the first computational flow graph includes: grouping the original vertices in the original computational flow graph according to input data and output data of the original vertices in the original computational flow graph to obtain the first computational flow graph. In this embodiment, the original vertices may be grouped according to a dependency relationship of the input data and the output data to obtain a vertex in the first computational flow graph.

The criteria for said grouping may also include computational resource requirements of the original vertices. If the computational resources required by successive original vertices are the same, for example, the computational resources required by a plurality of successive original vertices are all 2 parts of computational resources (including computing units, storage space, and the like) or 4 parts of computational resources, the plurality of successive original vertices may be grouped together to form a vertex in the first computational flow graph.

The criteria for said grouping may also include: determining whether the original vertices may perform computations or operations in parallel. For example, for the original vertices in two branches located behind the same original vertex in the original computational flow graph, if the requirements for the computational resources required by the original vertices in the two branches do not change much, the original vertices in the two branches may be grouped together to form a vertex in the first computational flow graph.

In an exemplary embodiment, FIG. 3 illustrates the first computational flow graph formed after the original vertices of resnet50 being grouped. The original vertices of a resnet50 network are divided into four vertices according to preset criteria, i.e., group 1, group2, group3 and group4. The four vertices have data dependencies. That is, output data of group1 is input data of group2, output data of group2 is input data of group3, output data of group3 is input data of group4, and output data of group4 is output data of resnet50.

In the present disclosure, the specific criteria for grouping are not limited, and different grouping algorithms corresponding to different grouping criteria may be used to group the original vertices in the original computational flow graph to obtain the vertices in the first computational flow graph.

Referring back to FIG. 1, the method for computational flow graph scheduling scheme generation further includes: step S102, determining a number N of computing units required for parallel processing of a single batch of computational data according to storage resource requirements of the vertices in the first computational flow graph and storage resources of the computing units, N being an integer greater than or equal to 1.

Optionally, the storage resource requirements of the vertices in the first computational flow graph include storage resource requirements of each computational stage of the vertices in the first computational flow graph, e.g., storage requirements of the input data, storage requirements of intermediate computational results, and storage requirements of the output data.

Optionally, the step S102 may further include:
step S401, acquiring a maximum storage requirement of the vertices in the first computational flow graph; and
step S402, calculating the number N of computing units required for parallel processing of a single batch of computational data according to the maximum storage requirement and the storage resources of the computing units.

In the step S401, the maximum storage requirement of the vertices in the first computational flow graph is acquired. Optionally, the maximum requirement includes a maximum storage requirement among storage requirements of the input data, storage requirements of intermediate computational results, and the storage requirements of the output data.

In an exemplary embodiment, taking the aforementioned resnet50 as an example, the storage requirements of respective vertices are as follows:

| | | Intermediate | |
|---|---|---|---|
| | | computational results | Output data |
| Group | Input data (KB) | storage (KB) | (KB) |
| 1 | 294 | 3528 | 784 |
| 2 | 784 | 1764 | 392 |
| 3 | 392 | 882 | 196 |
| 4 | 196 | 441 | 2 |

If the storage resources can meet the maximum storage requirement, the storage resources are able to meet the storage requirements of the other vertices. Therefore, the maximum storage requirement of the vertices in the first computational flow graph is acquired first in this step. In the above example, the maximum storage requirement is 3528 KB corresponding to the intermediate computational result of vertex Group1.

Each deep learning model requires hardware resources to perform graph scheduling on the model. In one example, the resnet50 model is subjected to graph scheduling using NPU STCP920 developed by the applicant, and there are eight computing units in NPU that can perform efficient matrix multiplication and convolution operations, where each computing unit has an exclusive Level-1 high-speed cache of 1280 KB, and the eight computing units share a Level-2 low-speed cache with sufficient space. In this example, where the storage resource of the computing unit is 1280 KB, in S402, the number N of computing units required for parallel processing of a single batch of computational data is calculated according to the maximum storage requirement and the storage resources of the computing units.

Optionally, the number N may be determined according to the storage resources required to meet the maximum storage requirement. If 3,528 KB of data is to be stored, at least three storage resources are required, and the number N of the required computing units may be determined to be 3.

However, if N=3, two computing units are idle when the above eight computing units process data. To this end, optionally, the step S102 further includes:
calculating the number N of the computing units according to the following formula: 2^{[log}^{₂}^{[M/m]]},
where M represents the maximum storage requirement, and m represents a size of a storage space of a single computing unit.

Based on the above example, if the maximum storage requirement is 3528 KB and if the storage resource of a single computing unit is 1280 KB, N may be calculated as 4 when they are substituted into the above formula. That is, four computing units are required to process a batch of data.

Referring back to FIG. 1, the method for computational flow graph scheduling scheme generation further includes: S103, making N copies of first computational flow graphs to obtain a second computational flow graph.

In this step, the first computational flow graph obtained in step S101 is copied by the number N. In the N copies of the first computational flow graphs, N batches of data may be processed in parallel. It may be understood that the first computational flow graph represents a logic for data processing. However, in actual data processing, the processing made by each vertex in the first computational flow graph is performed by the corresponding hardware such as the computing unit.

The step S103 may further includes:
replicating the first computational flow graph by the number N; and
combining the number N of first computational flow graphs to generate the second computational flow graph, wherein the second computational flow graph is used for parallel processing of a plurality of batches of data.

That is, after the number N of first computational flow graphs are copied, the N first computational flow graphs are combined to generate the second computational flow graph. The combination includes: using the vertices in the N first computational flow graphs as the vertices in the second computational flow graph, and using directed edges between the vertices in the N first computational flow graphs as directed edges of the vertices in the second computational flow graph. FIG. 5 is an exemplary schematic diagram of the second computational flow graph.

Referring back to FIG. 1, the method for computational flow graph scheduling scheme generation further includes: step S104, adding auxiliary vertices into the second computational flow graph to obtain a third computational flow graph.

The auxiliary vertices include: a first auxiliary vertex representing an input data reading operation in the original computational flow graph, a second auxiliary vertex representing an intermediate result computational operation for the vertexes in the original computational flow graph, and a third auxiliary vertex representing a computation terminating operation in the second computational flow graph.

In the existing schemes, the original computational flow graph, which is produced by a deep learning model in a way such that a computational operation is taken as a vertex, only focuses on the computational process of the input data in the model, but ignores the impact of parameter data of the model on the computing and storage requirements during the execution of the model. In this step, the auxiliary vertices are added to the second computational flow graph to supplement a life cycle (e.g., the first auxiliary vertex represents the start of model computation, the second auxiliary vertex represents an intermediate execution process of the model, and the third auxiliary vertex represents the termination of model computation), storage space occupation and other model parameter data information during the execution of the model for the original computational flow graph, so as to provide more complete information for the subsequent design of the model scheduling scheme. These pieces of information may help designers derive a model scheduling scheme more conveniently, and reduce the workload of analyzing the feasibility of different model scheduling schemes and comparing the advantages and disadvantages of performances.

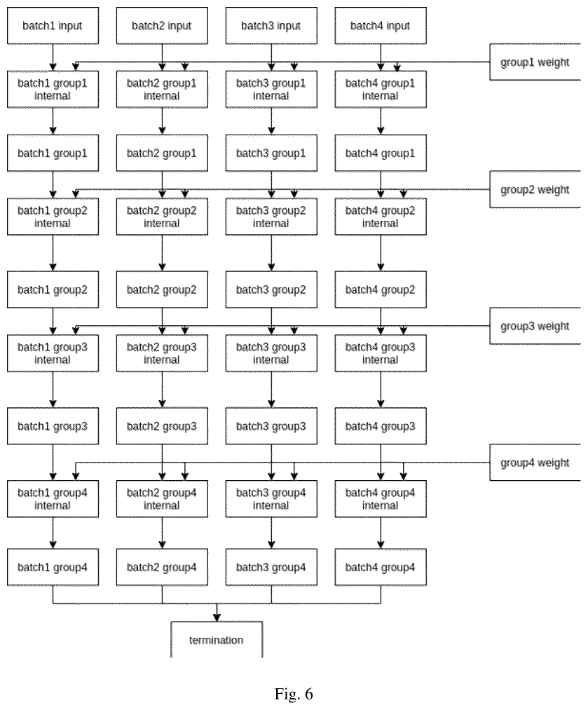

FIG. 6 illustrates an exemplary schematic diagram of the third computational flow graph. Vertices other than those in the second computational flow graph are auxiliary vertices. For example, batch1 input and group1 weight are first auxiliary vertices representing an input data reading operation in the original computational flow graph, where batch1 input represents reading of input data of first sample data, and group1 weight represents reading of weight data of the model. The other first auxiliary vertices are similar by analogy and will not be repeated. Batch1 group1 internal represents an intermediate result computational operation of the first sample data in the group1 vertex, which is a second auxiliary vertex, and other second auxiliary vertices are similar by analogy and will not be repeated. Termination represents the third auxiliary vertex representing the computation termination operation in the second computational flow graph.

Returning to FIG. 1, the method for computational flow graph scheduling scheme generation further includes: step S105, constructing an integer linear programming problem corresponding to the third computational flow graph according to the third computational flow graph.

In the integer programming problem, both an objective function and constraints are both linear optimization problems. However, the integer linear programming (ILP) problem requires that all unknown quantities are integers. That is, by constructing the objective function with the consumption in the computation process as an unknown quantity, and by taking the performances of hardware resources as the constraints, the integer linear programming problem can be constructed, while a solution of this integer linear programming problem is the scheduling scheme.

In an exemplary embodiment, the step S105 includes:
obtaining values of R_{t,i}, S_{t,i}, L_{t,i} and F_{t,i}, such that a value of the following polynomial is minimum:

Σₜ₌₁^{T}Σᵢ₌₁^{N}(L_{t,i}+S_{t,i})Cᵢ (Formula 1)
where i indicates a serial number of the vertex in the third computational flow graph; t indicates a time step; R_{t,i} indicates whether the result of the i^{th} vertex is computed at a t^{th} time step; S_{t,i} indicates whether the computational result of the i^{th} vertex is stored in the low-speed cache at the t^{th} time step; L_{t,i} indicates whether the computational result of the i^{th} vertex is read from the low-speed cache to a cache of a computing unit at the t^{th} time step; F_{t,i} indicates whether a space occupied by the computational result of the i^{th} vertex in the cache of the computing unit is released at the t^{th} time step; Cᵢ indicates a consumption required to transmit the computational result of the i^{th} vertex between the low-speed cache and the cache of the computing unit; R_{t,i} is equal to 0 or 1, S_{t,i} is equal to 0 or 1, L_{t,i} is equal to 0 or 1, and F_{t,i} is equal to 0 or 1; 0 means not performing a corresponding operation, and 1 means performing the corresponding operation; T and N are integers greater than 1; wherein the integer linear programming problem further includes constraints of the R_{t,i}, S_{t,i}, L_{t,i} and F_{t,i}; and the constraints are determined by hardware performances of the computing unit.

Taking the above example as an example, according to the structure of the original computational flow graph and the hardware characteristics of NPU STCP920, the constraints of R_{t,i}, S_{t,i}, L_{t,i} and F_{t,i} are obtained are as follows:

$${\sum }_{t} {R}_{t , i} = 1 , i ∈ \{ 1 , … , N \}$$

$${\sum }_{t} {S}_{t , i} \leq 1 , i ∈ \{ 1 , … , N \}$$

$${S}_{t , i} \leq {\sum }_{k = 1}^{t} {R}_{k , i} - {\sum }_{k = 1}^{t - 1} {F}_{k , i} , t ∈ \{ 2 , … , T \} , i ∈ \{ 1 , … , N \}$$

$${S}_{t , i} \leq {\sum }_{k = 1}^{t} {R}_{k , i} , t ∈ \{ 2 , … , T \} , i ∈ \{ 1 , … , N \}$$

$${L}_{t , i} \leq {\sum }_{k = 1}^{t - 1} {S}_{t , i} , t ∈ \{ 2 , … , T \} , i ∈ \{ 1 , … , N \}$$

$$0 \leq {\sum }_{k = 1}^{t} ( {R}_{k , i} + {L}_{k , i} - {F}_{k , i} ) - {\sum }_{k = 1}^{t - 1} {S}_{k , i} \leq 1 , t ∈ \{ 2 , … , T - 1 \} , i ∈ \{ 1 , … , N \}$$

$${\sum }_{k = 1}^{T} ( {R}_{k , i} + {L}_{k , i} - {F}_{k , i} ) - {\sum }_{k = 1}^{T - 1} {S}_{k , i} = 0 , i ∈ \{ 1 , … , N \}$$

$${R}_{t , j} \leq {\sum }_{k = 1}^{t - 1} {R}_{k , i} - {\sum }_{k = 1}^{t - 1} {S}_{k , i} + {{\sum }^{t}}_{k = 1} {L}_{k , i} - {\sum }_{k = 1}^{t - 1} {F}_{k , i} , t ∈ \{ 1 , … , T - 1 \} , i ∈ \{ 1 , … , N \} , < i , j > ∈ DAG 3$$

$${S}_{T , i} = 0 , i ∈ \{ 1 , … , N \}$$

$${\sum }_{i = 1}^{N} ( {\sum }_{k = 1}^{t - 1} ( {R}_{k , i} + {S}_{k , i} - {F}_{k , i} ) + {\sum }_{k = 1}^{t} {L}_{k , i} ) \leq B * 1280 , t ∈ \{ 2 , … , T \}$$

$${\sum }_{i = 1}^{N} ( {\sum }_{k = 1}^{t} ( {R}_{k , i} + {S}_{k , i} - {F}_{k , i} + {L}_{k , i} ) ) \leq B * 1280 , t ∈ \{ 2 , … , T \}$$

A construction method of a binary integer programming problem is used in the above method of constructing the integer linear programming problem. In practice, other methods for constructing the integer programming problem may also be used. For example, in a construction method of a multivariate integer programming problem, Rᵢ, Sᵢ, Lᵢ and Fᵢ are used to represent time steps of performing corresponding operations on a vertex i, that is, Rᵢ, Sᵢ, Lᵢ, Fᵢ∈{0, 1, . . . , T}\hat{ }4; Rᵢ=t means that a computational operation is performed on the vertex i in the time step t; Rᵢ=0 means that no computational operation is performed on the vertex i in the scheduling scheme; and the definitions of other operations are similar, so that a non-binary integer linear programming problem may be constructed correspondingly, which will not be repeated here.

The model scheduling problem is represented by the above mathematical formulas, and a definite optimization goal is set, so that the designer can use mathematical methods in the optimization theory to design and optimize the scheduling scheme.

Referring back to FIG. 1, the method for computational flow graph scheduling scheme generation further includes: step S106, solving the integer linear programming problem to obtain the scheduling scheme of the third computational flow graph.

After the objective function (e.g., Formula 1 above) and the constraints are acquired, a solution of the objective function under the constraints may be calculated. The step S106 refers to a process of solving the integer linear programming problem to obtain a solution that minimizes the objective function, i.e., the scheduling scheme of the third computational flow graph.

Optionally, the step S106 includes:
encoding the integer linear programming problem; and
solving the encoding to obtain an execution sequence of the vertices in the third computational flow graph.

That is, the objective function and the constraints constructed in the step S105 are encoded, and then an execution sequence of the vertices in the third computational flow graph is obtained by running the encoding.

Optionally, the integer linear programming problem may be solved using existing toolkits. For example, the above problem may be encoded and solved using a Python extension package pulp, wherein pulp is a Python extension package developed for linear programming problems, which provides a language specification for describing the linear programming problems, and encapsulates interfaces that can be called by python, for solvers of various linear programming problems. It may be understood that the constructed integer linear programming problem may also be encoded in any other programming language. The encoded integer linear programming problem may be solved by any software with the ability to solve the linear programming problem, which will not be repeated here.

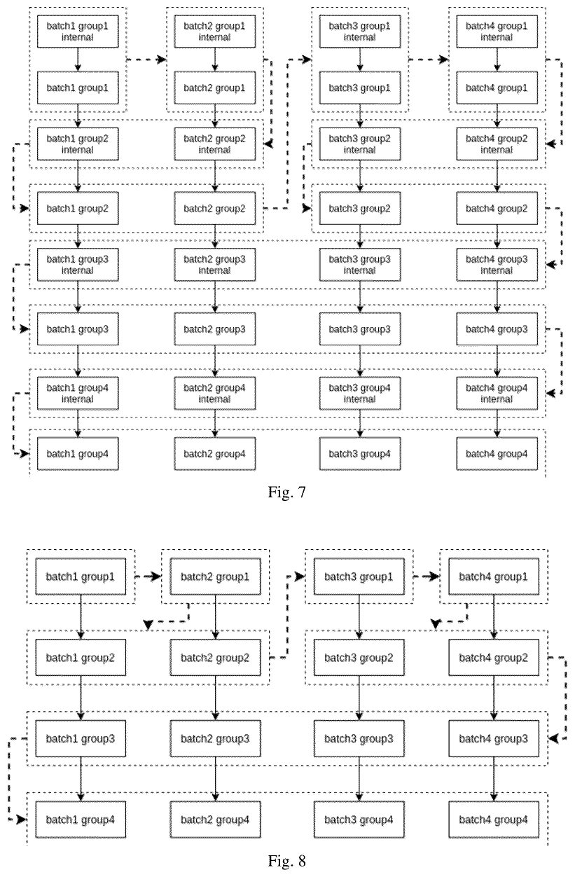

FIG. 7 is a schematic diagram of an execution sequence of vertices in the third computational flow graph obtained by solving the integer linear programming problem. Since the first auxiliary vertices only represent the input of data, the execution sequence of the first auxiliary vertices is related to their corresponding vertices, that is, the computation will start after reading the data. This execution sequence of the first auxiliary vertices has no effect on the execution sequence of other vertices in the third computational flow graph, and is only used to construct the above integer linear programming problem, so the first auxiliary vertices are not shown.

Referring back to FIG. 1, the method for computational flow graph scheduling scheme generation further includes: step S107, simplifying the scheduling scheme of the third computational flow graph to form a scheduling scheme of the second computational flow graph.

The third computational flow graph includes auxiliary vertices, which are only for the purpose of providing complete information for the scheduling scheme. Therefore, in practice, these vertices may be removed. Accordingly, the step S107 includes:
deleting the auxiliary vertices in the scheduling scheme of the third computational flow graph to obtain the scheduling scheme of the second computational flow graph. FIG. 8 illustrates the scheduling scheme of the second computational flow graph obtained by simplifying the scheduling scheme of the third computational flow graph. The scheduling scheme of the second computational flow graph is a final scheduling scheme.

In order to maximize the performances of a hardware device actually used, the method for computational flow graph scheduling scheme generation further includes:
determining an amount of data processed by each vertex in the scheduling scheme according to the number of computing units and the number N.

As in the above example, the scheduling scheme of the second computational flow graph is to process four batches of data with four processing units, but NPU contains eight computing units. Therefore, in order to maximize the computing power, the amount of data processed by each vertex in the scheduling scheme can be doubled. It may be understood that each vertex represents a logic for data processing, while it is the computing unit corresponding to the vertex that actually processes the data.

The above embodiment discloses a method for computational flow graph scheduling scheme generation. The method for computational flow graph scheduling scheme generation includes: grouping original vertexes in an original computational flow graph to obtain a first computational flow graph, the vertices in the first computational flow graph being at least one set formed by the vertices in the original computational flow graph; determining a number N of computing units required for parallel processing of a single batch of computational data according to storage resource requirements of the vertices in the first computational flow graph and storage resources of the computing units, N being an integer greater than or equal to 1; making N copies of first computational flow graphs to obtain a second computational flow graph; adding auxiliary vertices into the second computational flow graph to obtain a third computational flow graph; constructing an integer linear programming problem corresponding to the third computational flow graph according to the third computational flow graph; solving the integer linear programming problem to obtain a scheduling scheme of the third computational flow graph; and simplifying the scheduling scheme of the third computational flow graph to form a scheduling scheme of the second computational flow graph. According to the method for computational flow graph scheduling scheme generation, the technical problems of low data reuse rate or low parallelism in the prior art are solved by converting the original computational flow graph into the third computational flow graph and constructing the integer linear programming problem to obtain the scheduling scheme.

It can be seen from the above embodiments that the traditional model scheduling scheme design requires the designers to have rich experience in DL model optimization and be able to deeply understand the structural characteristics of the DL model that needs to be scheduled currently. The use of an automated algorithm proposed in the present disclosure can circumvent this reliance on expert experience. Manually designing a model scheduling scheme requires designers to spend a lot of time to verify and compare the effects of different scheduling schemes, which requires a lot of time and manpower. The scheduling scheme of the DL model can be produced within a short period of time by using the automation algorithm proposed in the present disclosure, which greatly saves manpower and time costs. As mentioned above, due to the designers' own experience limitations and different understandings of model characteristics, different designers may derive model scheduling schemes with different performances for DL models with different structures, and it is difficult to prove whether the derived scheduling scheme is optimal. The global optimal scheduling scheme may be stably derived for DL models with different structures by using the automation method proposed in the present disclosure.

In addition, the traditional design of the scheduling scheme of the computational flow graph only focuses on the scheduling optimization problem of a single batch of data running on the computational flow graph, which cannot solve the problem of wasting computing resources caused by the low parallelism of a vertex in the computational flow graph when the amount of data is small. The method proposed by the present disclosure converts the problem into a scheduling optimization problem in which a plurality of batches of data run many times on the computational flow graph through the copying and merging of the computational flow graphs, and expands the boundary of a feasible scheduling scheme set, such that a scheduling scheme with a high degree of computational parallelism in all vertices can be found in a larger scheduling scheme space, and the waste of computing resources is reduced, thereby improving the overall performances of execution of the computational flow graph.

Embodiments of the present disclosure also provide an apparatus for computational flow graph scheduling scheme generation, comprising:
a first computational flow graph generating module, configured to group original vertexes in an original computational flow graph to obtain a first computational flow graph, each group being a vertex in a first computational flow graph, the vertex being a set formed by at least one original vertex in the original computational flow graph;
a computing unit number determining module, configured to determine a number N of computing units required for parallel processing of a single batch of computational data according to storage resource requirements of the vertices in the first computational flow graph and storage resources of the computing units, N being an integer greater than or equal to 1;
a second computational flow graph generating module, configured to make N copies of the first computational flow graphs to obtain a second computational flow graph;
a third computational flow graph generating module, configured to add auxiliary vertices into the second computational flow graph to obtain a third computational flow graph;
an integer linear programming problem constructing module, configured to construct an integer linear programming problem corresponding to the third computational flow graph according to the third computational flow graph;
an integer linear programming problem solving module, configured to solve the integer linear programming problem to obtain a scheduling scheme of the third computational flow graph; and
a simplifying module, configured to simplify the scheduling scheme of the third computational flow graph to form a scheduling scheme of the second computational flow graph.

Optionally, the first computational flow graph generating module is further configured to: group the original vertices in the original computational flow graph according to input data and output data of the original vertices in the original computational flow graph to obtain the first computational flow graph.

Optionally, the computing unit number determining module is further configured to: acquire a maximum storage requirement of the vertices in the first computational flow graph; and calculate the number N of computing units required for parallel processing of the single batch of computational data according to the maximum storage requirement and the storage resources of the computing units.

Optionally, the computing unit number determining module is further configured to: calculate the number N of the computing units according to the following formula: 2^{[log}^{₂}^{[M/m]]}, where M represents the maximum storage requirement, and m represents a size of a storage space of a single computing unit.

Optionally, the second computational flow graph generating module is further configured to: replicate the first computational flow graph by the number N; and combine the number N of the first computational flow graphs to generate the second computational flow graph, wherein the second computational flow graph is used for parallel processing of a plurality of batches of data.

Optionally, the auxiliary vertices comprise: a first auxiliary vertex representing an input data reading operation in the original computational flow graph, a second auxiliary vertex representing an intermediate result computational operation for the vertexes in the original computational flow graph, and a third auxiliary vertex representing a computation terminating operation in the second computational flow graph.

Optionally, the integer linear programming problem constructing module is further configured to: obtain values of R_{t,i}, S_{t,i}, L_{t,i} and F_{t,i}, such that a value of the following polynomial is minimum:

$${\sum }_{t = 1}^{T} {\sum }_{i = 1}^{N} ( {L}_{t , i} + {S}_{t , i} ) {C}_{i}$$

where i indicates a serial number of the vertex in the third computational flow graph; t indicates a time step; R_{t,i} indicates whether the result of the i^{th} vertex is calculated at a t^{th} time step; S_{t,i} indicates whether the computational result of the i^{th} vertex is stored in a low-speed cache at the t^{th} time step; L_{t,i} indicates whether the computational result of the i^{th} vertex is read from the low-speed cache to a cache of a computing unit at the t^{th} time step; F_{t,i} indicates whether a space occupied by the computational result of the i^{th} vertex in the cache of the computing unit is released at the t^{th} time step; Cᵢ indicates a consumption required to transmit the computational result of the i^{th} vertex between the low-speed cache and the cache of the computing unit; R_{t,i} is equal to 0 or 1, S_{t,i} is equal to 0 or 1, L_{t,i} is equal to 0 or 1, and F_{t,i} is equal to 0 or 1; 0 means not performing a corresponding operation, and 1 means performing the corresponding operation; T and N are integers greater than 1; wherein the integer linear programming problem further comprises constraints of the R_{t,i}, S_{t,i}, L_{t,i} and F_{t,i}; and the constraints are determined by hardware performances of the computing unit.

Optionally, the integer linear programming problem solving module is further configured to: encode the integer linear programming problem; and solve the encoding to obtain an execution sequence of the vertices in the third computational flow graph.

Optionally, the simplifying module is further configured to: delete the auxiliary vertices in the scheduling scheme of the third computational flow graph to obtain the scheduling scheme of the second computational flow graph.

Optionally, the apparatus for computational flow graph scheduling scheme generation is further configured to: determine an amount of data processed by each vertex in the scheduling scheme according to the number of computing units and the number N.

Embodiments of the present disclosure further provide an electronic device, including: a memory for storing computer-readable instructions; and one or more processors for executing the computer-readable instructions, which, upon execution, cause the processors to implement any one of the methods for computational flow graph scheduling scheme generation in the above embodiments.

Embodiments of the present disclosure further provide a non-transitory computer-readable storage medium, the non-transitory computer-readable storage medium storing computer-readable instructions for causing a computer to execute any one of the methods for computational flow graph scheduling scheme generation in the above embodiments.

Embodiments of the present disclosure further provide a computer program product, including computer instructions, wherein, when the computer instructions are executed by a computing device, the computing device performs any one of the methods for computational flow graph scheduling scheme generation in the above embodiments.

The flowcharts and block diagrams in the accompanying drawings of the present disclosure show the possible architecture, functions, and operations of the system, method, and computer program product according to various embodiments of the present disclosure. In this regard, each block in the flowcharts or block diagrams may represent a module, a program segment or a part of codes, and the module, the program segment or the part of the codes contains one or more executable instructions for implementing the defined logical functions. It should also be noted that in some implementations as alternatives, the functions labeled in the blocks may occur in an order different from the order labeled in the accompanying drawings. For example, two sequentially shown blocks may be substantially executed in parallel in fact, and they sometimes may also be executed in a reverse order, depending on related functions. It should also be noted that each block in the block diagrams and/or the flowcharts and the combination of the blocks in the block diagrams and/or the flowcharts may be implemented by a dedicated system based on hardware for executing defined functions or operations, or may be implemented by a combination of the dedicated hardware and computer instructions.

The units described in the embodiments of the present disclosure may be implemented in a software fashion or may be implemented in a hardware fashion. The names of the units do not constitute a limitation to the units in some cases.

The functions described above herein may be performed, at least in part, by one or more hardware logic components. For example, non-restrictively, exemplary types of hardware logic components that can be used include: a field programmable gate array (FPGA), an application-specific integrated circuit (ASIC), an application-specific standard product (ASSP), a system on chip (SOC), a complex programmable logic device (CPLD), and the like.

In the context of the present disclosure, a machine-readable medium may be a tangible medium that may contain or store a program for use by or in conjunction with an instruction execution system, apparatus or device. The machine-readable medium may be a machine-readable signal medium or a machine-readable storage medium. The machine-readable medium may include, but not limited to, an electronic, magnetic, optical, electromagnetic, infrared or semiconductor system, apparatus or device, or any suitable combination of the foregoing. A more specific example of the machine-readable storage medium includes an electrical connection based on one or more wires, a portable computer disk, a hard disk, a random-access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination of the above content.

What is claimed is:

1. A method for computational flow graph scheduling scheme generation, comprising:
grouping original vertexes in an original computational flow graph to obtain a first computational flow graph, each group being a vertex in the first computational flow graph, the vertex being a set formed by at least one original vertex in the original computational flow graph;
determining a number N of computing units required for parallel processing of a single batch of computational data according to storage resource requirements of the vertices in the first computational flow graph and storage resources of the computing units, N being an integer greater than or equal to 1;
making N copies of the first computational flow graphs to obtain a second computational flow graph;
adding auxiliary vertices into the second computational flow graph to obtain a third computational flow graph;
constructing an integer linear programming problem corresponding to the third computational flow graph according to the third computational flow graph;
solving the integer linear programming problem to obtain a scheduling scheme of the third computational flow graph; and
simplifying the scheduling scheme of the third computational flow graph to form a scheduling scheme of the second computational flow graph.

2. The method for computational flow graph scheduling scheme generation according to claim 1, wherein grouping the original vertexes in the original computational flow graph to obtain the first computational flow graph comprises:
grouping the original vertices in the original computational flow graph according to input data and output data of the original vertices in the original computational flow graph to obtain the first computational flow graph.

3. The method for computational flow graph scheduling scheme generation according to claim 1, wherein determining the number N of computing units required for parallel processing of the single batch of computational data according to the storage resource requirements of the vertices in the first computational flow graph and the storage resources of the computing units comprises:
acquiring a maximum storage requirement of the vertices in the first computational flow graph; and
calculating the number N of computing units required for parallel processing of the single batch of computational data according to the maximum storage requirement and the storage resources of the computing units.

4. The method for computational flow graph scheduling scheme generation according to claim 3, wherein determining the number N of computing units required for parallel processing of the single batch of computational data according to the maximum storage requirement and the storage resources of the computing units comprises:
calculating the number N of the computing units according to the following formula: 2^{[log}^{₂}^{[M/m]]},
where M represents the maximum storage requirement, and m represents a size of a storage space of a single computing unit.

5. The method for computational flow graph scheduling scheme generation according to claim 1, wherein making N copies of the first computational flow graphs to obtain the second computational flow graph comprises:
replicating the first computational flow graph by the number N; and
combining the number N of the first computational flow graphs to generate the second computational flow graph, wherein the second computational flow graph is used for parallel processing of a plurality of batches of data.

6. The method for computational flow graph scheduling scheme generation according to claim 1, wherein the auxiliary vertices comprise:
a first auxiliary vertex representing an input data reading operation in the original computational flow graph, a second auxiliary vertex representing an intermediate result computational operation for the vertexes in the original computational flow graph, and a third auxiliary vertex representing a computation terminating operation in the second computational flow graph.

7. The method for computational flow graph scheduling scheme generation according to claim 1, wherein constructing the integer linear programming problem corresponding to the third computational flow graph according to the third computational flow graph comprises:
obtaining values of R_{t,i}, S_{t,i}, L_{t,i} and F_{t,i}, such that a value of the following polynomial is minimum:
$${\sum }_{t = 1}^{T} {\sum }_{i = 1}^{N} ( {L}_{t , i} + {S}_{t , i} ) {C}_{i}$$
where i indicates a serial number of the vertex in the third computational flow graph; t indicates a time step; R_{t,i} indicates whether the result of the i^{th} vertex is calculated at a t^{th} time step; S_{t,i} indicates whether the computational result of the i^{th} vertex is stored in a low-speed cache at the t^{th} time step; L_{t,i} indicates whether the computational result of the i^{th} vertex is read from the low-speed cache to a cache of a computing unit at the t^{th} time step; F_{t,i} indicates whether a space occupied by the computational result of the i^{th} vertex in the cache of the computing unit is released at the t^{th} time step; Cᵢ indicates a consumption required to transmit the computational result of the i^{th} vertex between the low-speed cache and the cache of the computing unit; R_{t,i} is equal to 0 or 1, S_{t,i} is equal to 0 or 1, L_{t,i} is equal to 0 or 1, and F_{t,i} is equal to 0 or 1; 0 means not performing a corresponding operation, and 1 means performing the corresponding operation; T and N are integers greater than 1; wherein the integer linear programming problem further comprises constraints of the R_{t,i},S_{t,i}, L_{t,i} and F_{t,i}; and the constraints are determined by hardware performances of the computing unit.

8. The method for computational flow graph scheduling scheme generation according to claim 1, wherein solving the integer linear programming problem to obtain the scheduling scheme of the third computational flow graph comprises:
encoding the integer linear programming problem; and
solving the encoding to obtain an execution sequence of the vertices in the third computational flow graph.

9. The method for computational flow graph scheduling scheme generation according to claims 1, wherein simplifying the scheduling scheme of the third computational flow graph to form the scheduling scheme of the second computational flow graph comprises:
deleting the auxiliary vertices in the scheduling scheme of the third computational flow graph to obtain the scheduling scheme of the second computational flow graph.

10. The method for computational flow graph scheduling scheme generation according to claim 1, further comprising:
determining an amount of data processed by each vertex in the scheduling scheme according to the number of computing units and the number N.

11. An electronic device, comprising: a memory configured to store computer-readable instructions; and one or more processors, configured to execute the computer-readable instructions, which, upon execution, cause the processors to implement the method according to claim 1.

12. A non-transitory computer-readable storage medium, configured to store computer instructions therein, wherein the computer instructions are configured to cause a computer to perform the method according to claim 1.
